(19) United States
(12) Patent Application Publication
(10) Pub. No.: US 2011/0003034 A1
(43) Pub. Date: Jan. 6, 2011

(54) FOOD PRODUCTS COMPRISING SESAME PASTE

(76) Inventor: Yoram Netzer, Rosh Ha'ayin (IL)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/742,911

(22) PCT Filed: Nov. 13, 2008
(86) PCT No.: PCT/IL2008/001488

§ 371 Date: Sep. 7, 2010

Related U.S. Application Data
(60) Provisional application No. 60/987,645, filed on Nov. 13, 2007.

(51) Int. Cl. A23L 1/36; A23G 9/42; A23L 1/187; A23C 11/10; A23G 9/34; A23L 1/236; A23G 9/36; A23L 3/34

(52) U.S. Cl. 426/61; 426/629; 426/564; 426/565; 426/573; 426/634; 426/548; 426/324

(57) ABSTRACT

Sesame paste-based non-dairy, egg-free food products comprising sesame paste, natural fruit juice and/or natural fruit pulp, are provided as alternatives to common dairy and/or egg containing food products such as sorbet, soft ice cream, pudding, yogurt, frozen yogurt and snacks.

### FIELD OF THE INVENTION

The present invention relates to nutritious food products and, particularly, to non-dairy, egg-free products comprising sesame paste, fruit juice and/or fruit pulp, and to sesame paste-based non-dairy yogurts.

### BACKGROUND OF THE INVENTION

More than ever before, there is a growing awareness and concern in the population regarding the nutritional requirements and the importance of consuming healthy food products for achieving an optimum quality of life. The growing interest in the field of nutrition has led consumers to strive for new nutritious food products, thus encouraging manufacturers and suppliers of food products to explore and develop healthier foods. Moreover, health conscious consumers are now seeking healthier alternative foods that are delectable and at the same time boost their energy and stimulate their immune systems. Thus, the knowledge of how to produce food products that meet the nutritional and health requirements of today, while still being delicious and enjoyable, has become instrumental for the wellbeing of the public.

The necessity to address the special dietary needs of a relatively large portion of population which is allergic to a variety of food ingredients such as lactose, gluten, albumin, and/or of people suffering from high cholesterol levels, obesity and the like, motivates the search for a healthier, yet at least as tasty, alternatives for common desserts and appetizers.

The oval-shaped seeds of the sesame plant Sesamum indicum are one of the oldest seeds known as an important oilseed crop. Africa is considered to be the primary centre of origin of this crop, and India and Japan are considered as secondary centers of origin. Sesame seed contains a high percentage of oil (ca 55%), and has a very good stability due to the presence of natural anti-oxidants. Sesame oil is extensively used for cooking, manufacturing perfumed oils and medicine.

There are three types of sesame seeds distinguished by their color: white, brown and black seeds. The white-seeded varieties have higher oil content compared to the black-seeded. The testa color of the white seeds ranges from cream to white, of the brown seeds ranges from light-brown to dark-brown, and of the black seeds ranges from dark-brown to black. White sesame seeds have a nutty flavor, while black seeds taste slightly bitter.

Sesame seeds are featured in many traditional Asian cuisines. Spice paste concoction made with sesame seeds enhance Indian dishes, and sesame play a role in Japanese vegetarian cooking. In China, sesame seeds are used for flavoring savory dishes.

Sesame paste obtained from grinding the sesame seeds has a rich aroma and resembles peanut butter in color and texture. In Mediterranean countries, the sesame paste, known as “tahini”, is prepared from untoasted seeds. Toasting sesame seeds to make sesame paste is a time honored culinary technique, giving the paste a different flavor than tahini.

The sesame seeds are also used in sweet confections. Baking and preparation of sweets and confectionery (e.g., benne cakes) with sesame seed provide desserts as a rich source of protein, carbohydrates, and minerals like calcium and phosphorous. Tahini is used in a Middle Eastern confection called “halvah”. In India, sections of the Middle East and East Asia, popular treats are made from sesame mixed with honey or syrup and roasted (called pasteli in Greece). In Japanese cuisine goina-dofu is made from sesame paste and starch.

Sesame seeds and/or sesame paste have been reported to be incorporated into frozen desserts along with dairy ingredients. JP 1107500 describes a soft ice-cream comprising sesame paste. CN 1057948, JP 03297353 and CN 1078865 disclose a dairy ice-cream comprising sesame paste. US 2006/0078651 describes a dairy ice-cream comprising sesame paste and a nutritional supplement. CN 1158222 describes a “crisp” dairy ice-cream containing sesame “skin” and cracker crisp.

CN 1036310 and CN 1078861 describe sesame ice cream bars. CN 1078861 describes an ice-cream bar having 3-4% sesame juice made of raw sesame. CN 10783103 discloses a dairy ice-cream made of cooked black rice and ground sesame seeds.

JP 06078681 discloses ice-cream made of pumpkin or plum, mashed sesame, rice powder, cream and milk. JP 2006262854 describes a frozen dessert made of sugar, fat, and one or more fruits or vegetables such as: pumpkin, banana, mango, citrus fruits, sesame, etc.

U.S. Pat. No. 5,962,062 and CA 2542180 describe dairy ice-creams having a vegetable oil, which may be sesame oil.

It would be highly desirable to provide a non-dairy and egg free food product, particularly a sweet snack, refresher or dessert, containing sesame paste that would meet the needs of providing an all natural, as well as gluten- lactose-, albumin- and cholesterol-free alternative that not only appeals to the public because of its superior flavor, but also possesses a high nutritional index suitable to a population with special diet needs.

### SUMMARY OF THE INVENTION

In one aspect, the present invention provides a non-dairy, egg-free food product comprising sesame seed paste, natural fruit juice and/or natural fruit pulp.

In another aspect, the present invention provides a sesame paste-based non-dairy yogurt that may optionally contain natural fruit juice and/or natural fruit pulp.

In addition to being free of dairy ingredients and eggs, the product according to the invention is gluten-, cholesterol-, and albumin-free, and as such is particularly suitable for a wide range of population with special diet needs.

The food product of the invention may be frozen or not. In one preferred embodiment, the product is frozen and, most preferably, it a sesame paste-based sorbet, soft ice cream or frozen yogurt. In another preferred embodiment, the non-dairy, egg-free product is not frozen and comprises, preferably, yogurt, pudding or snacks.

The food products of the invention comprise preferably natural ingredients, more preferably organic ingredients, such as organic fruits and organic sesame seeds. Any fruit available in its natural season such as strawberry, blackberry, cranberry, cherry, grapefruit, pomegranate, mango, papaya, orange, apple, grape, lychee, lemon, tangerine, persimmon, melon, peach, apricot, plum, guava, dates, pineapple, fig, banana, passion fruit, coconut or a mixture thereof, can be used for the preparation of the non-dairy food product of the invention.

The present invention further provides a process for the preparation of a sesame paste-based sorbet and soft ice cream.

### DETAILED DESCRIPTION OF THE INVENTION

The present invention provides, in a main aspect, novel high nutritive value non-dairy and egg-free food products based on polyunsaturated vegetable fats originating from sesame seeds. The food products provided by the invention contain no animal fat, eggs, or dairy ingredients such as milk or cream, and as such they are cholesterol-free, gluten-free and have low calorie content. These products provide a healthier alternative and, particularly, address the needs of allergic individuals presenting susceptibility e.g., to gluten, lactose, eggs and/or individuals suffering from high cholesterol levels and/or obesity.

In one preferred embodiment, the present invention provides a non-dairy, egg-free food product comprising sesame paste, natural fruit juice and/or natural fruit pulp.

In a more preferred embodiment, the sesame paste used according to the invention is the crude paste known as “tahini”. The tahini may comprise any of the known variety of sesame seeds, namely, white, brown, black or any combination thereof. In a most preferred embodiment, the sesame paste is made of white seeds.

The sesame paste may be made from hulled seeds, namely seeds that were skinned of their shell, or the paste may be made from whole seeds and thus be richer in minerals, especially calcium, which reside in the shell. In one preferred embodiment, the sesame paste in made from hulled seeds. In another preferred embodiment, the sesame paste is a “whole paste”, i.e., made from unhulled seeds.

Many types of fruits can be used for the preparation of the non-dairy, egg-free products of the invention. Non-limiting examples include strawberry, blackberry, blueberry, cherry, cranberry, grapefruit, pomegranate, kiwifruit, mango, papaya, orange, apple, grape, lychee, lemon, tangerine, persimmon, melon, peach, apricot, plum, guava, dates, pineapple, fig, banana, passion fruit, coconut or a mixture thereof.

In a most preferred embodiment of the invention, the non-dairy food products are organic food products namely, comprise ingredients, which are cultivated organically, or derived from organically grown fruits or vegetables.

The products provided by the invention do not comprise milk or cream nor eggs and are, therefore, healthy and nutritious substitutes for common food products, especially sweet food products such as desserts, snacks and refreshers. The non-dairy, egg-free food products of the invention are designed to resemble known dairy and egg-containing products in appearance, texture and taste. For convenience reasons, the products of the invention are named herein according to the dairy and/or egg products for which they represent alternatives. Thus, it is to be understood that the food products herein designated “mousse”, “pudding”, “custard”, “sorbet”, “gelato”, “mellorine”, “frozen custard”, “yogurt”, “frozen yogurt” or “soft ice cream” are in fact mousse-like, pudding-like, custard-like, sorbet-like, gelato-like, mellorine-like, frozen custard-like, yogurt-like, frozen yogurt-like, or soft ice cream-like food products based on sesame paste, and contain no dairy ingredients or eggs.

The sesame paste-based food product of the invention may further comprise ingredients that contribute to the texture, look and palatability of the products or provide additional nutritional and/or therapeutic value. These additional ingredients include, but are not limited to, (a) soymilk; (b) natural supplement selected from nutraceuticals, nutrients, colorants or flavorants such as vanilla; (c) dietary fibers such as bamboo fibers or Chicory fibers (Inulin); (d) chocolate; or (e) carob.

Thus, in one embodiment, sweet, unfrozen, sesame paste-based products are provided selected from mousse, fruit shake, sherbet, pudding, custard, or snacks.

In another preferred embodiment, frozen products are provided selected from sorbet, frozen fruit puree, gelato, mellorine, frozen custard or soft ice cream.

In one preferred embodiment, the invention provides non-dairy, egg-free snacks, more preferably an alternative snack to the chocolate-coated marshmallow treats known in the United States as “Mallomars”. The snack comprises a circular biscuit or Graham cracker base on the bottom and whipped egg white cream or a puff of extruded marshmallow from above, coated with a thin layer of chocolate, which forms a hard shell. According to the invention, the sesame paste replaces the puff inside. This snack is produced in different variations around the world, with several countries claiming to have invented it or hailing it as their “national confection.” In the United Kingdom this confection is known as a chocolate teacake or Tunnocks, in Canada it is called Whippet, in the Netherlands the name is “Negerzoenen” (“Negro kiss”), in Germany it is “Schokoküsse”, and in France the name is tête de choco (“chocolate heads”) or simply meringue au chocolat (“chocolate meringue”). In Israel this dessert is called “Krembo” (literally “cream-in-it”), and it is a very popular alternative to ice-cream during winter time.

In most preferred embodiments of the invention, the frozen sesame-based products or refreshers of the invention are sorbet or soft ice cream.

Classically, “sorbet” refers to the frozen fruit dessert typically made with a sweetener and a fruit puree. Sorbet evolved from sherbet, a cooled drink served widely in the Middle East, prepared from fruit juices, sugar, and water or ice. Unlike gelato, sorbet is made vegan, meaning that it contains no animal products, and it tends to be slightly softer than gelato. It also tends to be lower in fat than many other frozen fruit desserts, as it contains no animal products. Because sorbet is not typically thinned with water, it tends to be very dense and intensely flavored.

In the United States, sherbet and sorbet are synonyms and often confused with Water Ice and Italian Ice. The American sorbet/sherbet must also include dairy ingredients such as milk or cream to reach a milk fat content between 1% and 2%. Products with higher milkfat content are defined as ice cream; products with lower milkfat content are defined as water ice.

The sorbet provided by the present invention contains sesame paste, fruit juice and/or fruit pulp and thinned with water. The sorbet of the invention is dense and even in texture, unlike the slushy ice or a granular granita. It is made like ice cream and gelato by slowly freezing down the ingredients while mixing them constantly to create an even, consistent texture.

The fruit pulp or fruit puree content in the sorbets of the present invention is lowered as compared to a classical sorbet by thinning with water and/or fruit juice, but unlike classical sherbet it is not based solely on fruit syrup and water, has non-dairy fat content of between 1 and 2%, and may further comprise stabilizers and emulsifiers useful in the manufacture of ice cream. Preferably, the fruit juice and/or fruit puree content in the sorbet of the invention is 30-65%, more preferably about 40%.

The products of the invention may be categorized into three groups, herein designated: “standard”, “premium” and “supper premium”. The standard group included products containing up to 32% fruit and additives, stabilizers and emulsifiers, which are commonly used in the food industry.

The premium products contain at least 40% fruit and all the additives, stabilizers and emulsifiers used are 100% natural ingredients. The supper premium products contain at least 40% fruit and all ingredients are organic. These products are also categorized as organic food products.

The non-dairy, egg-free products of the invention may be sweetened with a natural sweetener selected from, but not limited to, sucrose, corn syrup, honey, glucose, dextrose, fructose, date honey, maple syrup or maltodextrin.

In a preferred embodiment of the invention, sucrose is the main sweetener and the dessert may contain from 10 to 20% sucrose. In a more preferred embodiment, the products is sweetened primarily with sucrose and further contains glucose, honey and/or date honey (also known as date syrup), each in amounts ranging from 1 to 5% of the total mass.

In another embodiment, the products may be sweetened with sugar alcohols which technically are not artificial sweeteners, and are herein referred to as semi-artificial sweeteners. Examples include sorbitol, xylitol, lactitol, mannitol, isomalt, and maltitol, which are used to sweeten “sugar-free” foods such as candy, cookies, and chewing gum.

The non-dairy, egg free products of the invention may also be sweetened with an artificial sweetener selected from, but not limited to, saccharin, aspartame, sucralose, neotame or acesulfame potassium.

According to one preferred embodiment, the product of the invention contains the main following ingredients: fruit juice and/or fruit pulp in amounts ranging from 30 to 65%, preferably 50 to 60%; crude sesame seed past (tahini) in amounts ranging from 1 to 3%, preferably 1.5 to 2.5%; sucrose in amounts ranging from 10 to 23%, preferably 13 to 18%; at least additional natural or semi-artificial sweeteners in amounts ranging from 1 to 5.5%, preferably 1.5 to 4%; and water, up to 50% of the total mass. The product may further contain stabilizers and emulsifiers, depending on the texture desired. The additional, one, preferably two or three natural or semi-artificial sweeteners in the product may be glucose, honey, date honey or maltitol.

Most preferably, the sweet non-dairy, egg free product provided by the invention is a sesame paste-based sorbet or soft ice cream, which comprise (i) sesame paste from white sesame seeds; (ii) fruit juice and/or fruit pulp, wherein said fruit is strawberry, blackberry, cranberry, cherry, grapefruit, kiwifruit, pomegranate, mango, papaya, orange, apple, grape, lychee, lemon, tangerine, persimmon, melon, peach, apricot, plum, guava, dates, pineapple, fig, banana, pear, passion fruit, coconut, or a mixture thereof; and (iii) natural sweeteners selected from sucrose, honey or date honey.

In most preferred embodiment, the sorbet or soft ice cream are selected from pomegranate, red grapefruit, grape, coconut, or lychee sorbet or soft ice cream.

In a further aspect, the present invention provides sesame paste-based non-dairy yogurt.

The thick, custard- or pudding-like yogurt provided by the invention is made by the natural bacterial fermentation, wherein the bacteria are grown on sugars other than lactose, most preferably dextrose.

The process of making dairy yogurt involves culturing cream or milk with live and active bacterial cultures; this is accomplished by adding bacteria directly to the milk, wherein the bacteria use the milk sugar lactose for growth. Commercially made yogurt is mostly made with cultures of Lactobacillus acidophilus and Streptococcus thermophilis, but other cultures may be useful such as Lactobacillus bulgaricus Lactobacillus casei, Lactobacillus rhamnosus or Bifidobacterium bifidium, Lactobacillus lactis. Acidophilus is touted for its many health benefits, some of which have been known about for thousands of years.

Soy yoghurt (also termed soygurt) a commonly marked vegan substitute for the dairy yogurt, is prepared using soymilk, yogurt bacteria, mainly Lactobacillus bulgaricus and Streptococcus thermophilus and sometimes additional sweetener, like fructose, glucose, honey or raw sugar. Soymilk has about the same amount of protein (though not the same amino acid profile) as cow's milk, but unlike cow's milk it has little saturated fat and no cholesterol, which is a benefit.

Recent studies concerning soy products consumption and its short- and long-term effects on human health, have raised questions over whether the ingredients in soy might increase the risk of breast cancer in some women, inhibit the production of sperm in men, affect brain function and lead to hidden developmental abnormalities in infants.

The core of soy critics' concerns rests with the chemical makeup of soy: in addition to all the nutrients and protein, soy contains an impressive array of natural phytochemicals (biologically active components derived from plants), the most interesting of which are known as isoflavones, which mimic estrogen, the female hormone, and thus may alter sexual development. Soybeans also contain high levels of an anti-nutrient called “phytic acid”, which may block the absorption of certain minerals, including magnesium, calcium, iron and zinc.

The non-dairy yogurt of the present invention addresses the need for a daily-basis consumed food product having the beneficial effects of yogurt but devoid of the harmful effects of cow milk and soymilk. The yogurt comprises sesame paste, and at least one bacterial culture selected from Streptococcus thermophilus, Bifidobacterium bifidium, Lactobacillus bulgaricus, Lactobacillus acidophilus, Lactobacillus casei, Lactobacillus rhamnosus, or Lactobacillus lactis, preferably Streptococcus thermophilus or Lactobacillus acidophilus, and sugar as substrate for bacterial growth, preferably dextrose. This product is a rich source of absorbable calcium, manganese, magnesium, copper, iron, zinc, vitamins, minerals and proteins.

According to a more preferred embodiment, the sesame paste-based non-dairy yogurt comprises: (i) fruit juice and/or fruit pulp, wherein said fruit is selected from strawberry, blackberry, cranberry, cherry, grapefruit, kiwifruit, pomegranate, mango, papaya, orange, apple, grape, lychee, lemon, tangerine, persimmon, melon, peach, apricot, plum, guava, dates, pineapple, fig, banana, pear, passion fruit, coconut or a mixture thereof; (ii) natural sweeteners selected from sucrose, honey or date honey, preferably honey; and optionally, at least one semi-artificial sweeteners; (iii) one or more stabilizers; and (iv) an emulsifier.

In a preferred embodiment, the sesame paste-based non-dairy yogurt of the invention may further comprise soymilk, however the amount of soymilk is, at most, half of the amount used in common soy yogurts.

The sesame paste-based non-dairy yogurt of the invention may be enjoyed in a variety of ways, most likely as a cool dish either naturally flavored or mixed with fruits. The yogurt can be used to make healthy shakes or frozen to eat like ice cream. The non-dairy yogurt can also be used when cooking, in place of milk, sour cream, and even some cheeses.

In one more preferred embodiment, the sesame paste-based non-dairy yogurt is served as a frozen dish, i.e., frozen yogurt.

The fats in the non-dairy products of the invention originate from sesame seeds. In addition, the sesame seeds provide minerals such as manganese, magnesium, copper, iron, zinc and calcium (90 mg per tablespoon for unhulled seeds, 10 mg for hulled), and contain vitamins such as B1, B6 (thiamine) and E (tocopherol). Just a quarter-cup of sesame seeds supplies 74.0% of the daily value (DV) for copper, 31.6% of the DV for magnesium, and 35.1% of the DV for calcium. This rich assortment of minerals translates into important health benefits such as possible relief for rheumatoid arthritis imparted by copper, which is a trace mineral important in a number of anti-inflammatory and antioxidant enzyme systems; Magnesium supports vascular and respiratory health, whereas calcium helps to prevent colon cancer, osteoporosis, migraine and PMS; zinc may be beneficial for bone health, making sesame-containing food valuable for bone mineral density especially for older men and women.

In addition to these important nutrients, sesame seeds contain two unique substances: sesamin and sesamolin that belong to a group of special beneficial fibers called lignans, and have been shown to have a cholesterol-lowering effect in humans and to prevent high blood pressure and to increase vitamin E supplies. Sesamin has also been found to protect the liver from oxidative damage.

Sesame seeds further contain phytosterols, which lower cholesterol levels. Phytosterols are compounds found in plants, have a chemical structure very similar to cholesterol, and when present in the diet in sufficient amounts, are believed to reduce blood levels of cholesterol, enhance the immune response and decrease risk of certain cancers. Sesame seeds have the highest total phytosterol content (400-413 mg per 100 gr) as compared to other seeds and nuts.

Another important factor contributing to the high nutritive value of sesame seeds is their high content of polyunsaturated fatty acids (PUFA). It is suggested that the presence of high levels of polyunsaturated fatty acids in sesame oil might help in controlling blood pressure and lowering the amount of medication needed to control hypertension. Sesame oil is unique in that it has high concentrations of omega-6 fatty acids, particularly linoleic acid, which is present in amounts ranging from 35 to 50%.

The nutrients of sesame seeds are better absorbed if the seeds are ground or pulverized before consumption.

Any of the non-dairy, egg-free food products of the invention may further comprise a natural supplement selected from a nutraceutical, nutrient, dietary fiber, colorant or flavorant.

Nutraceuticals provide medical or health benefits, including the prevention and treatment of disease and include, without limitation, flavonoids, antioxidants such as gamma-linolenic acid, beta carotene and anthocyanins, dietary supplements such as folic acid or any other nutraceuticals approved by the FDA.

Nutrient is a substance essential to an organism's metabolism or physiology, which cannot be synthesized by the organism in sufficient quantities and must be obtained from an external source. Nutrients useful for the purpose of the invention include, without being limited to, organic nutrients such as carbohydrates, fats, proteins (or their building blocks, amino acids), vitamins, and inorganic chemical compounds such as minerals.

In certain preferred embodiments of the invention, the non-dairy, egg-free food products may contain stabilzer(s). The stabilizers are a group of compounds, usually polysaccharide food gums that are responsible for adding viscosity and firmness to the product. Introduction of stabilizers into the products results in many functional benefits for frozen as well as for the unfrozen products. Stabilizers extend the shelf life of frozen products such as sorbet by limiting ice re-crystallization during storage. Without the stabilizers, the frozen product would become coarse and icy very quickly due to the migration of free water and the growth of existing ice crystals. Stabilizers help to prevent heat shock effects resulting from partial melting followed by re-freezing. The stabilizers also stabilize the air bubbles and hold the flavourings. Thus, they prevent shrinkage from collapse of the air bubbles. In addition, at the time of consumption, the stabilizers promote good flavour release and provide some body and mouth feel without being gummy.

In non dairy, egg-free products such snacks, custard or mousse, the stabilizers provide the required firmness for the product.

The stabilizers useful for the purpose of the present invention include, but are not limited to, locust bean gum, guar gum, carboxymethyl cellulose, xantham gum, sodium alginate, gelatin or carrageenan, preferably guar gum or carrageenan.

Each of the stabilizers has its own characteristics and often, two or more of these stabilizers may be used in combination to obtain synergistic effect. Guar, for example, is more soluble than locust bean gum at cold temperatures, thus it is more applicable for the frozen products of the present invention. Carrageenan is generally not used by itself but rather as a secondary colloid to prevent the whey off of mix, which is usually promoted by one of the other stabilizers.

The non-dairy, egg-free products of the present invention may, preferably, contain an emulsifier. The emulsifiers are a group of compounds, which aid in developing the appropriate fat structure and air distribution necessary for the smooth eating and good meltdown characteristics desired particularly in frozen food products. The emulsifier molecules reside at the interface between fat and water, and as a result they act to reduce the interfacial tension or the force, which exists between the two phases of the emulsion. The emulsifiers actually promote a destabilization of the fat emulsion, which leads to a smooth, dry product with good meltdown properties.

The traditional ice cream emulsifier was egg yolk, which was used in most of the original recipes. Today, two emulsifiers predominate most frozen food formulations: mono- and di-glycerides, derived from the partial hydrolysis of fats or oils of animal or, more preferably for the purpose of the present invention, of vegetable origin, primarily derived from soybean and canola oil. Together, the stabilizers and emulsifiers make up less than one half percent by weight of the products of the invention. They are all compounds which have been exhaustively tested for safety and have received the “generally recognized as safe” (GRAS) status.

In another aspect, the present invention provides processes for the preparation of the non-dairy food products of the invention. These processes combine techniques known in the food industry for the preparation of frozen and non-frozen products, with techniques specially designed for the present sesame paste based products.

In a preferred embodiment, the invention provides a process for the preparation of a non-dairy sorbet, which comprises the following steps:

a. preparing a mixture herein designated “ice cream mix”, comprising blending water, sweetener(s), stabilizer(s) and emulsifier(s), followed by pasteurizing;

b. preparing a pasteurized mixture of sesame paste and fruit juice and/or fruit pulp;

c. combining the pasteurized mixture obtained in (b) with the ice cream mix obtained in (a) and homogenizing the mass;

d. cooling the homogenized mass to a temperature of 4-8° C.;

e. transferring the homogenized mass obtained in (c) into an ice cream machine for half-way freezing; and

f. packaging the half-way freezed mass in containers, and shock freezing it at −30° to −40° C., followed by deep freezing at −28° C. for at least 24 hours to obtain said non-dairy sorbet.

Thus, first the ice cream mix is prepared and pasteurized. As used herein the term “ice cream mix” refers to a blend of water, sucrose, glucose, stabilizer and emulsifier.

In a separate process, a sesame paste obtained from either hulled or whole (unhulled) seeds ground in grindstones is heated to a temperature around 100° C. and mixed with fresh fruit juice and/or fruit pulp, such that the juice and/or pulp is heated and subsequently pasteurized. The heat generated from pasteurizing the sesame paste is thus used for pasteurizing the fruit juice.

Prior to grinding by grindstones into a paste, the sesame seeds are collected and monitored for their quality and ripeness, and then undergo selection based on their size.

The next step in the preparation of the frozen sesame paste-based food products of the invention, is combining the ice cream mix with the pasteurized mass which comprises the sesame seed paste and fruit juice and, optionally, the fruit pulp, and homogenizing the resulting mixture. Homogenizing forms the fat emulsion in the presence of an emulsifier, makes a smoother texture, gives a greater apparent richness and palatability, better air stability and increases resistance to melting. Since sesame seed paste readily mixes with water, homogenization of the mix can take place at ambient temperature.

Following homogenization, the mass is cooled from a temperature of 80-90° C. down to a temperature of 4-8° C., then transferred to an ice cream machine and enters the dynamic freezing process, which both freezes a portion of the water and whips air into the frozen mix. This stage in the process is termed “aging”. Any ice cream machine or ice cream maker commonly used in the manufacture of ice cream may be suitable for the purpose of the invention.

The frozen food products of the invention, particularly sorbet and soft ice cream, contain a considerable quantity of air, up to half of their volume. This gives the products their characteristic lightness. Without air, the refresher would be similar to a frozen ice cube. The semi-frozen slurry obtained up op this point in the process, wherein about half of its water is frozen, has a consistency similar to soft-serve dessert.

After the product, preferably sorbet, is half-way frozen, it is packaged in containers, and placed into a blast freezer at −30° to −40° C. where most of the remainder of the water is immediately frozen in a process termed “shock freezing” or “hardening”. The shock freezing enables faster hardening, which provides a smoother product. For packaging of the sorbet, any containers commonly used for marketing of frozen food products may be suitable as long as the package type does not impede heat transfer during the hardening process. Thus, for example, styrofoam liner or corrugated cardboard may protect against heat shock after hardening, but reduces heat transfer during freezing so they are not feasible.

Following the immediate hardening stage, the containers are transferred to a deep freezer and maintained at a temperature of about −28° for at least 24 hours before the product is marked. The sorbet is stable for indefinite periods at this temperature without danger of ice crystal growth; however, above this temperature, ice crystal growth is possible and the rate of crystal growth is dependant upon the temperature of storage.

In one preferred embodiment, the frozen product, preferably sorbet, of the invention is defrosted or softened back into its liquid condition, and transferred into a soft ice cream machine to obtain a soft ice cream (also termed “American ice cream”), which is consumed in situ.

### EXAMPLES

### Example 1

### General Process for the Preparation of a Sesame Paste-Based Sorbet

The sorbet is prepared by combining two masses prepared separately: the ice-cream mix and the sesame seed paste, and processing the combined mass according to standard process known in the art of ice cream manufacture.

### (a) Preparation of the Ice Cream Mix

The mix is prepared by blending water, sweetener(s), stabilizer(s) and emulsifier(s), in a container followed by pasteurizing. A quantity of 1000 ml of the ice cream mix contains: water in amounts ranging from 500 to 800 ml, preferably 650 to 750 ml; sucrose or semi artificial sweetener in amounts ranging from 100 to 250 gr, preferably from 150 to 220 gr; glucose, in amounts ranging from 35 to 55 gr, preferably from 45 to 55 gr; a stabilizer in amounts ranging from 1.5 to 7.7 gr, preferably 2.5 to 6.8 gr; and an emulsifier in amounts ranging from 1.6 to 7.5 gr, preferably 2.8 to 6.8 gr.

### (b) Preparation of Sesame Seed Paste

Sesame seeds are collected and monitored for their quality and ripeness, and undergo size selection using a mechanical filter. The sifted seeds are rinsed and soaked in sweet water, following which they are hulled, immersed in salt water to facilitate the separation of the hull from the grain, and finally drained in a centrifuge. After thoroughly drying the seeds (in a steam oven), they are ground by grindstones into a paste.

### (c) Preparation of Fruits

The fruits used for the preparation of the sorbet are first checked for their quality, and after rinsing they are extracted by squeezing. The fibers and pulp are separated and collected and may later be combined with the juice for the preparation of a thicker or richer product.

### (d) Preparation of the Unfrozen Mass

The ice cream mix obtained in (a) is combined with the pasteurized mass which comprises the sesame paste and fruit juice and/or fruit pulp obtained in (b) and (c), and the resulting mixture is homogenized.

### (e) Dynamic Freezing

Following homogenization, the mass obtained in (d) is transferred to an ice cream machine and enters the dynamic freezing process, which both freezes a portion of the water and whips air into the frozen mix.

### (f) Immediate Deep Freezing and Packaging

After the sorbet is half-way frozen, it is packaged in containers, shock freezed by placing it into a blast freezer at −30° to −40° C. where most of the remainder of the water is immediately frozen.

For packaging, any container commonly used for marketing of frozen food products is suitable, provided the package does not impede heat transfer during the hardening process.

Following the immediate hardening stage, the containers are transferred to a deep freezer and maintained at a temperature of about −28° for at least 24 hours before the product is marked.

### Example 2

### Non-Dairy, Egg-Free Sorbet

A non-dairy sesame paste-based sorbet may contain any kind of fruits, preferably available fresh, wherein fresh organic fruits in their natural season are more preferred. The sorbet comprises, per 1000 ml:

a. fruit juice and/or fruit pulp, from about 200 to about 600 gr, preferably from 300 to about 450 gr, wherein said fruit is selected from strawberry, blackberry, cranberry, cherry, grapefruit, kiwifruit, pomegranate, mango, papaya, orange, apple, grape, lemon, tangerine, persimmon, melon, peach, apricot, plum guava, dates, pineapple, fig, banana, pear, passion fruit, coconut or a mixture thereof;

b. natural sweeteners: sucrose from about 100 to about 220 gr, preferably from about 120 to about 180; honey from about 7 to about 20 gr, preferably 10 to 18 gr; and date honey from about 5 to about 20 gr, preferably 8 to 12 gr;

c. white sesame seed paste, from about 8.0 to about 25.0 gr, preferably from about 10 to 18 gr;

d. stabilizer, from about 0.7 to about 3.0 gr, preferably from about 1.5 to about 2.5 gr;

e. emulsifier, from about 0.7 to about 1.0 gr preferably from about 1.5 to about 2.5 gr;

f. lemon juice, from about 15 to about 35 ml, preferably from about 20 to about 30 ml; and

g. water, from about 350 to about 570 ml, preferably from about 450 to about 550 ml.

1. A non-dairy, egg-free food product comprising sesame paste, natural fruit juice and/or natural fruit pulp.

2. The non-dairy, egg-free food product according to claim 1, wherein said sesame paste is made form hulled sesame seeds selected from white, brown or black seeds, preferably hulled white seeds.

3. The non-dairy, egg-free food product according to claim 1, wherein said sesame paste is made form whole sesame seeds selected from white, brown or black seeds, preferably whole white seeds.

4. The non-dairy, egg-free food product according to any one of claims 1 to 3, wherein said fruit is strawberry, blackberry, cranberry, cherry, grapefruit, pomegranate, kiwifruit, mango, papaya, orange, apple, grape, lychee, lemon, tangerine, persimmon, melon, peach, apricot, plum, guava, dates, pineapple, fig, banana, passion fruit, coconut or a mixture thereof.

5. The non-dairy, egg-free food product according to claim 1, which is a sesame paste-based product selected from mousse, fruit shake, sherbet, pudding, custard, or snacks.

6. The non-dairy, egg-free food product according to claim 1, which is a sesame paste-based frozen product selected from sorbet, frozen fruit puree, gelato, mellorine, frozen custard or soft ice cream.

7. The non-dairy, egg-free food product according to claim 6, wherein said sesame paste-based frozen product is sorbet or soft ice cream.

8. The non-dairy, egg-free food product according to claim 1, further comprising at least one ingredient selected from: (a) soymilk; (b) natural supplement selected from nutraceuticals, nutrients, colorants or flavorants such as vanilla; (c) dietary fibers; (d) chocolate; or (e) carob.

9. The non-dairy, egg-free food product according to any one of claims 1 to 8, which is an organic food product.

10. The non-dairy, egg-free food product according to claim 1, sweetened with at least one natural sweetener selected from sucrose, corn syrup, honey, glucose, dextrose, fructose, date honey, maple syrup or maltodextrin.

11. The non-dairy, egg-free food product according to claim 1, sweetened with at least one semi-artificial sweetener selected from sorbitol, xylitol, lactitol, mannitol, isomalt, or maltitol.

12. The non-dairy, egg free food product according to claim 1, comprising: from 30 to 65%, preferably 40 to 50% fruit juice and/or fruit pulp; from 1 to 3%, preferably 1.5 to 2.5% sesame past; from 10 to 23%, preferably 13 to 18% sucrose; from 1 to 5.5%, preferably 1.5 to 4% of at least one additional natural or semi-artificial sweetener; from 0 to 0.3% of at least one stabilizer; from 0 to 0.1% emulsifier; and water, up to 50% of the total mass.

13. The non-dairy, egg-free food product according to claim 12, wherein said at least one additional natural or semi-artificial sweetener is selected from glucose, honey, date honey or maltitol.

14. The non-dairy, egg-free food product according to claim 12, which is sesame paste-based sorbet or soft ice cream comprising: (i) sesame paste from white sesame seeds; (ii) fruit juice and/or fruit pulp, wherein said fruit is strawberry, blackberry, cranberry, cherry, grapefruit, kiwifruit, pomegranate, mango, papaya, orange, apple, grape, lychee, lemon, tangerine, persimmon, melon, peach, apricot, plum, guava, dates, pineapple, fig, banana, pear, passion fruit, coconut, or a mixture thereof; and (iii) natural sweeteners selected from sucrose, honey or date honey.

15. The non-dairy, egg-free sesame paste-based sorbet or soft ice cream according to claim 14, selected from pomegranate, red grapefruit, grape, coconut, or lychee sorbet or soft ice cream.

16. The non-dairy, egg-free sorbet or soft ice cream according to claim 15, further comprising chocolate, carob, vanilla or a mixture thereof.

17. A sesame paste-based non-dairy yogurt.

18. The sesame paste-based non-dairy yogurt according to claim 17, comprising at least one bacterial culture selected from Streptococcus thermophilus, Bifidobacterium bifidium, Lactobacillus bulgaricus, Lactobacillus acidophilus, Lactobacillus casei, Lactobacillus rhamnosus, or Lactobacillus lactis, preferably Streptococcus thermophilus or Lactobacillus acidophilus, and sugar as substrate for bacterial growth, preferably dextrose.

19. The sesame paste-based non-dairy yogurt according to claim 17 or 18, further comprising soymilk.

20. The sesame paste-based non-dairy yogurt according to claim 17 or 18, further comprising: (i) fruit juice and/or fruit pulp, wherein said fruit is selected from strawberry, blackberry, cranberry, cherry, grapefruit, kiwifruit, pomegranate, mango, papaya, orange, apple, grape, lychee, lemon, tangerine, persimmon, melon, peach, apricot, plum, guava, dates, pineapple, fig, banana, pear, passion fruit, coconut or a mixture thereof; (ii) natural sweeteners selected from sucrose, honey or date honey, preferably honey; and optionally, at least one semi-artificial sweeteners; (iii) one or more stabilizers; and (iv) an emulsifier.

21. The sesame paste-based non-dairy yogurt according to claim 20, which is a frozen yogurt.

22. The sesame paste-based non-dairy yogurt according to any one of claims 17 to 21, which is an organic food product.

23. A process for the preparation of a sesame paste-based non-dairy sorbet according to claim 14, comprising the steps:
a. preparing a mixture, herein designated “ice cream mix”, comprising blending water, sweetener(s), stabilizer(s) and emulsifier(s), followed by pasteurizing;
b. preparing a pasteurized mixture of sesame paste and fruit juice and/or fruit pulp;
c. combining the pasteurized mixture obtained in (b) with the ice cream mix obtained in (a) and homogenizing the mass;
d. cooling the homogenized mass to a temperature of 4-8° C.;
e. transferring the cool homogenized mass obtained in (d) into an ice cream machine for half-way freezing; and
f. packaging the half-way freezed mass obtained in (e) in containers, and shock freezing it at −30° to −40° C., followed by deep freezing at −28° C. for at least 24 hours to obtain said sesame paste-based non-dairy sorbet.

24. The process according to claim 23, wherein the pasteurized mixture in (b) is obtained by mixing hot sesame paste with said fruit juice and/or fruit pulp, such that said fruit juice and/or fruit pulp is heated and subsequently pasteurized.

25. A process for the preparation of sesame paste-based non-dairy soft ice cream according to claim 14, comprising the steps:
a. preparing a mixture, herein designated “ice cream mix”, comprising blending water, sweetener(s), stabilizer(s) and emulsifier(s), followed by pasteurizing;
b. preparing a pasteurized mixture of sesame paste and fruit juice and/or fruit pulp;
c. combining the pasteurized mixture obtained in (b) with the ice cream mix obtained in (a) and homogenizing the mass;
d. cooling the homogenized mass to a temperature of 4-8° C.;
e. transferring the cool homogenized mass obtained in (d) into an ice cream machine for half-way freezing;
f. packaging the half-way freezed mass in containers and shock freezing it at −30° to −40° C., followed by deep freezing at −28° C. for at least 24 hours to obtain a sorbet; and
g. thawing the sorbet into a liquid and transferring the liquid into a soft ice cream machine to obtain said sesame paste-based non-dairy soft ice-cream.
